(19) United States
(12) Patent Application Publication
(10) Pub. No.: US 2023/0067139 A1
(43) Pub. Date: Mar. 2, 2023

(54) LEAKPROOF GAS-LIQUID MIXING PUMP

(71) Applicant: FANER AROMA PRODUCT CO., LTD., Guangzhou (CN)

(72) Inventors: JI-MIN ZHONG, Guangzhou (CN); CHAO-QIANG CHEN, Guangzhou (CN); SONGWEN YE, Guangzhou (CN); YINGYAO LIU, Guangzhou (CN); HSU-HUI CHANG, New Taipei City (TW)

(21) Appl. No.: 17/460,350

(22) Filed: Aug. 30, 2021

(51) Int. Cl. B01F 5/12; B01F 3/04; F04B 13/00; B05B 7/00

(52) U.S. Cl. CPC B01F 5/12; B01F 3/04446; F04B 13/00; B05B 7/005; B01F 2215/0077; A47K 5/14

(57) ABSTRACT

A leakproof gas-liquid mixing pump has a lower shell body, a pressing member and an upper shell body, the lower shell body has a liquid channel part and an outer shell part, the pressing member has a pressing part, a liquid guiding part and a first spring, the upper shell body surrounds the pressing member and is connected to the outer shell part and the liquid container. The leakproof gas-liquid mixing pump solves the problem that the gas-liquid mixing pump of the state of the art will leak when used upside down.

### BACKGROUND OF THE INVENTION

### 1. Field of the Invention

The present disclosure relates to a gas-liquid mixing pump, and in particular to a leakproof gas-liquid mixing pump that can be used upside down.

### 2. Description of the Related Art

Foam pumps have been widely used in everyday life, people set up foam pumps on containers, foam pumps suck up the liquid in the container by pressing, and mixed with gas to form a foam.

However, such foam pumps often have problems that are prone to leakage when upside down. As shown in FIG. 7, the foam pump of the state of the art uses ball B as a one-way valve. When the foam pump is upside down, the liquid is on top, ball B follows the direction of gravity G and leaves the original closed position, so that the liquid flows out of the gap between ball B and the wall of pipe, thus causing the liquid to drip from the opening until the liquid is completely leaking.

### BRIEF SUMMARY OF THE INVENTION

Therefore, in order to solve the problems of the traditional foam pump, the invention provides a leakproof gas-liquid mixing pump that can be used upside down.

To achieve the above objective and other objectives, the present disclosure provides a leakproof gas-liquid mixing pump that can be used upside down, and it is used for connecting a liquid container, characterized in that the leakproof gas-liquid mixing pump comprises: a lower shell body, which comprises a liquid channel part and an outer shell part, the outer shell part surrounds the liquid channel part; a pressing member, which comprises a pressing part, a liquid guiding part and a first spring, the pressing part has a gas-liquid mixing channel, the liquid guiding part is communicated one-way towards the pressing part, the first spring abuts between the pressing part and the lower shell body to make the liquid guiding part set movably in the liquid channel part, a liquid space is formed between the liquid guiding part and the liquid channel part, the liquid container is communicated one-way towards the liquid space through the liquid channel part, the liquid space is communicated one-way towards the liquid guiding part, a gas space is formed between the pressing part, the liquid channel part and the outer shell part, the gas space is communicated one-way towards the pressing part, and the outer atmosphere is communicated one-way towards the gas space; and an upper shell body, which surrounds the pressing member and is connected to the outer shell part and the liquid container; wherein the liquid guiding part comprises a cover part, a sealing piston, a second spring and a tube shaft which is communicated one-way towards the pressing part, the cover part is connected to a bottom end of the tube shaft, the diameter of the cover part is greater than the diameter of the tube shaft and less than the diameter of the liquid channel part, the tube shaft is set at least one through hole near the cover part, the second spring makes the sealing piston abut against the cover part to seal the through hole, so that the liquid space is communicated one-way towards the tube shaft.

In an embodiment of the invention, an outer perimeter of the cover part projects towards the sealing piston, and the sealing piston abuts against the outer perimeter.

In an embodiment of the invention, the sealing piston has a guiding bevel, the guiding bevel is located on the inside of the bottom of the sealing piston and close to the cover part.

In an embodiment of the invention, the liquid guiding part comprises an abutting top ring, the abutting top ring surrounds the tube shaft and abuts between the sealing piston and the second spring.

In an embodiment of the invention, the leakproof gas-liquid mixing pump further comprises two one-way valves, which are respectively located in the liquid channel part and the pressing part to make the liquid container communicated one-way towards the liquid space through the liquid channel part and make the liquid guiding part communicated one-way towards the pressing part.

In an embodiment of the invention, the leakproof gas-liquid mixing pump further comprises a one-way intake piston, the one-way intake piston is sleeved on the pressing part so that the external atmosphere is communicated one-way towards the gas space.

In an embodiment of the invention, the one-way intake piston is a soft piston.

In an embodiment of the invention, the leakproof gas-liquid mixing pump further comprises a mesh gas-liquid mixing piece, which is set in the pressing part.

In an embodiment of the invention, the leakproof gas-liquid mixing pump further comprises a one-way intake valve body, the one-way intake valve body is set in the pressing part to make the gas space communicated one-way towards the pressing part.

Therefore, the leakproof gas-liquid mixing pump of the invention that can be used upside down improves the shortcomings of the state of the art. When the leakproof gas-liquid mixing pump of the invention that can be used upside down is used upside down, the liquid does not drip out even if the pressing part is pressed down with a distance, or the liquid container is slightly squeezed, improving the stability of use. In addition, the leakproof gas-liquid mixing pump of the invention that can be used upside down can replace the traditional gravity steel ball one-way valve with a one-way valve of the butterfly valve disc, may be applied in any direction without fear of leakage, and the one-way valve of the butterfly valve disc can reduce the load than the gravity steel ball one-way valve.

### BRIEF DESCRIPTION OF THE DRAWINGS

FIG. 1 is a schematic explosive view of a leakproof gas-liquid mixing pump according to an embodiment of the present disclosure.

FIG. 2 is a schematic perspective view of the leakproof gas-liquid mixing pump according to the embodiment of the present disclosure.

FIG. 3 is a schematic sectional view of the leakproof gas-liquid mixing pump according to the embodiment of the present disclosure.

FIG. 4 is a schematic view in compression of the leakproof gas-liquid mixing pump according to the embodiment of the present disclosure.

FIG. 5 is a schematic view in a return of the leakproof gas-liquid mixing pump according to the embodiment of the present disclosure.

FIG. 6 is a schematic view in inversion of the leakproof gas-liquid mixing pump according to the embodiment of the present disclosure.

FIG. 7 is a schematic sectional view of the foam pump of the state of the art.

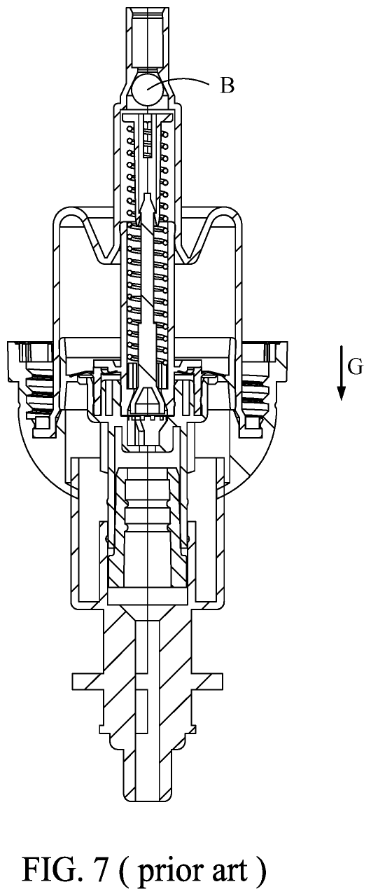

### DETAILED DESCRIPTION OF THE INVENTION

To facilitate understanding of the object, characteristics and effects of this present disclosure, embodiments together with the attached drawings for the detailed description of the present disclosure are provided. One skilled in the art can understand the object, characteristics and effects of this present invention by the content described in the specification. It should be noted that various possible modifications and alterations to the details of the specification could be carried out by implementing or applying other different embodiments based on different views and applications without departing from the spirit of the present invention. The related technical contents of the invention will be described in detail by the embodiments. However, the disclosed contents should not be considered to limit the scope of the invention. The description is provided as follows:

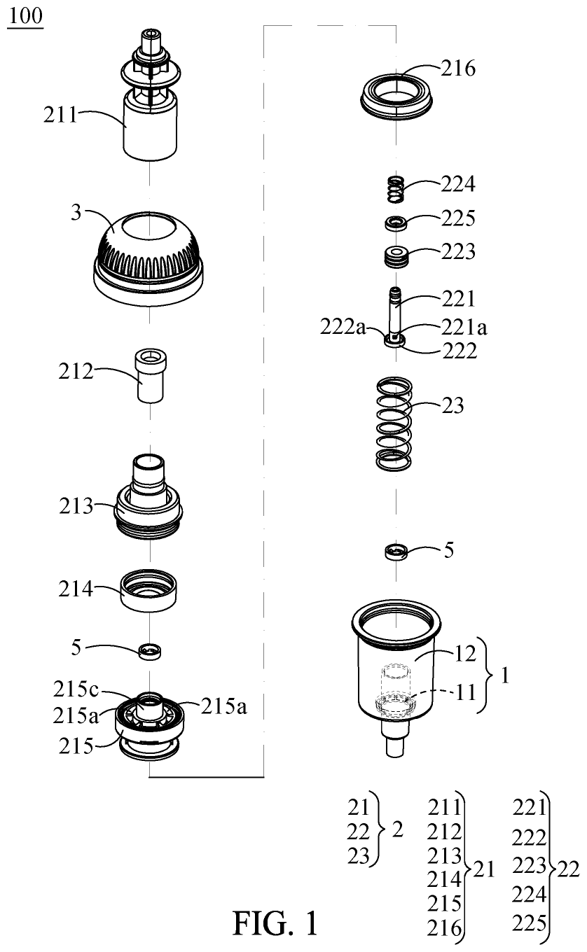

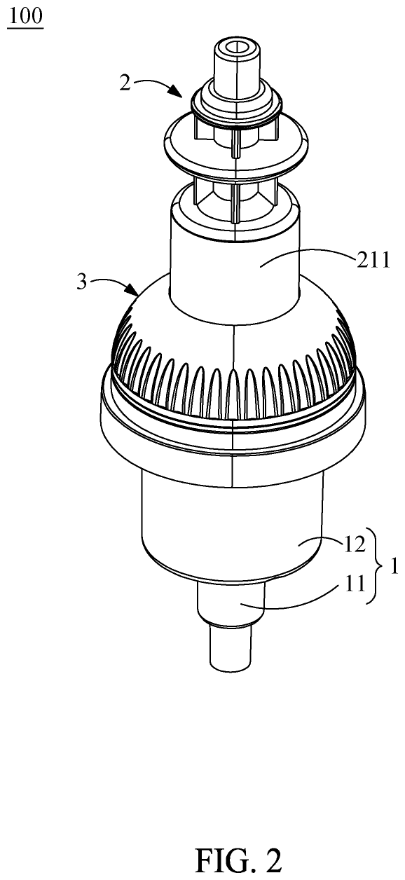

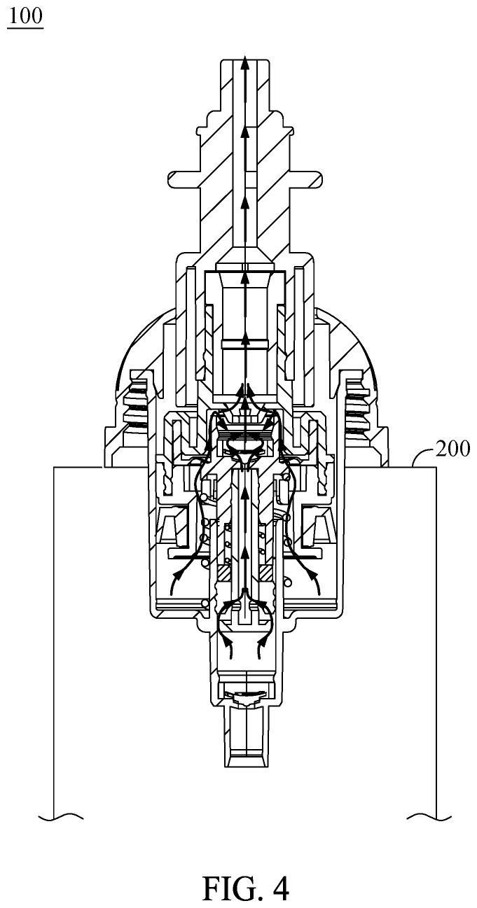

As shown in FIGS. 1 to 3, a leakproof gas-liquid mixing pump 100 of the invention that can be used upside down is used for connecting a liquid container 200 (referring to FIG. 4), the leakproof gas-liquid mixing pump 100 comprises a lower shell body 1, a pressing member 2 and an upper shell body 3.

The lower shell body 1 comprises a liquid channel part 11 and an outer shell part 12, the liquid channel part 11 is a hollow column, the outer shell part 12 surrounds the liquid channel part 11. A lower end of the liquid channel part 11 can be communicated one-way to the liquid container 200, the liquid container 200 can accommodate the liquid (e.g., soap liquid) to be sucked up, and the other end of the liquid channel part 11 is connected to the pressing member 2. The liquid channel part 11 and the outer shell part 12 can be placed in the liquid container 200 from an opening of the liquid container 200, so that the liquid channel part 11 sucks up the liquid in the liquid container 200.

The pressing member 2 has a pressing part 21, a liquid guiding part 22 and a first spring 23 for pressing by a user. The pressing part 21 has a pressing head 211, a sealed tube body 212, a first piston member 213, a one-way intake valve body 214, a second piston member 215 and a one-way intake piston 216 to be connected from top to bottom in sequence. The pressing head 211 may have a gas-liquid mixing channel 211a therein, the sealed tube body 212 is communicated between the pressing head 211 and the first piston member 213 to avoid the leakage between the pressing head 211 and the first piston member 213, the first piston member 213 may have a mesh gas-liquid mixing piece 213a therein, the mesh gas-liquid mixing piece 213a is a porous mesh member, a gas-liquid mixture can be foamed after it passed through the mesh gas-liquid mixing piece 213a, the one-way intake valve body 214 is connected between the first piston member 213 and the second piston member 215 to temporarily close a gas channel 215a of the second piston member 215, and the one-way intake valve body 214 can have a backstop film to prevent liquid from flowing into a gas space GS, causing uneven foam, a top of the second piston member 215 can have a gas-liquid mixing tube 215c, the gas-liquid mixing tube 215c may have a gas-liquid mixing space GLS therein, the mesh gas-liquid mixing piece 213a is communicated above the gas-liquid mixing space GLS, a bottom of the second piston member 215 may have an inner connection tube 215b, the one-way intake piston 216 is sleeved outside of the second piston member 215, and an outer edge of the one-way intake piston 216 is temporarily set against the inner wall of the outer shell part 12 of the lower shell body 1. The liquid guiding part 22 is communicated to the inner connection tube 215b of the second piston member 215 of the pressing part 21 and the liquid channel part 11 of the lower shell body 1, and the liquid guiding part 22 is communicated one-way towards the gas-liquid mixing tube 215c of the second piston member 215 of the pressing part 21, the liquid in the liquid container 200 mixes with the air after it goes through the liquid channel part 11 and the liquid guiding part 22, and then goes into the pressing part 21 to outflow in the form of foam. One end of the first spring 23 abuts against the bottom of the second piston member 215, the other end of the first spring 23 abuts against the bottom of the outer shell part 12, and the first spring 23 makes the liquid guiding part 22 set movably in the liquid channel part 11. A liquid space LS is formed between the liquid guiding part 22 and the liquid channel part 11, the liquid container 200 is communicated one-way towards the liquid space LS through the liquid channel part 11, the liquid space LS is communicated one-way towards the liquid guiding part 22, the gas space GS is formed between the pressing part 21, the liquid channel part 11 and the outer shell part 12, the gas space GS is communicated one-way towards the pressing part 21 through the one-way intake valve body 214, and the outer atmosphere is communicated one-way towards the gas space GS through the one-way intake piston 216. When the pressing part 21 is subjected to an external force and moves down in the drawing, the pressing part 21 may drive the liquid guiding part 22 down, the first spring 23 is compressed to accumulate elastic potential energy; when the external force at the pressing part 21 is removed, the first spring 23 releases the elastic potential energy to push the liquid guiding part 22 and the pressing part 21 to return.

The upper shell body 3 surrounds the pressing head 211 of the pressing part 21, and there is a gap between the upper shell body 3 and the pressing head 211, and the upper shell body 3 may be screwed to the opening of the liquid container 200. The outer shell part 12 of the lower shell body 1 is connected to the inside of the upper shell body 3, and an outer abutting top flange 213b of the first piston member 213 may temporarily set against the inner abutting top flange 31 in the upper shell body 3. The one-way intake valve body 214, the second piston member 215, the one-way intake piston 216 and the outer shell part 12 therebetween may be clamped to form the gas space GS, which can provide gas (e.g., air) for mixing into foam.

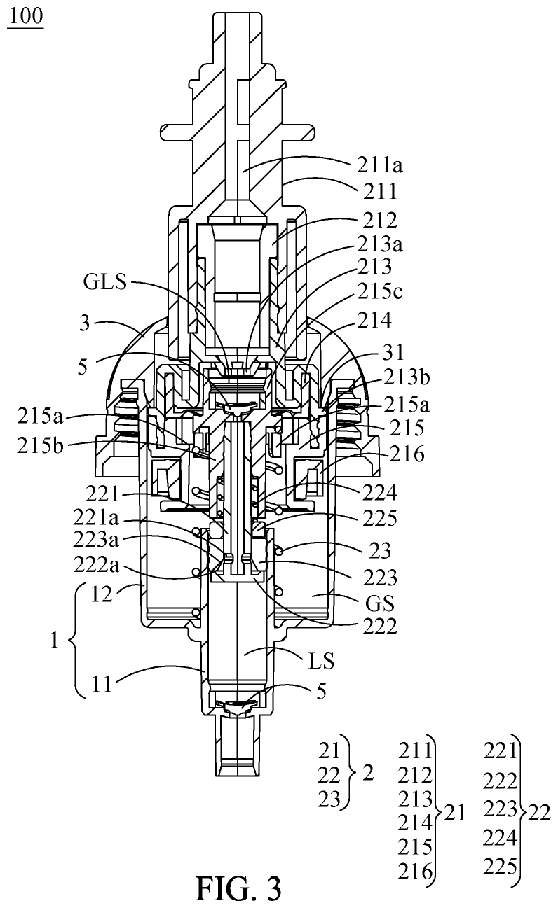

As shown in FIGS. 1 and 3, the liquid guiding part 22 comprises a cover part 222, a sealing piston 223, a second spring 224 and a tube shaft 221 which is communicated one-way towards the second piston member 215 of the pressing part 21. The tube shaft 221 is a hollow tube column, at least part of which is located in the liquid channel part 11. The cover part 222 is connected to a bottom end of the tube shaft 221 and is located in the liquid channel part 11, the bottom end of the tube shaft 221 is sealed by the cover part 222 without directly communicating the liquid channel part 11, the liquid space LS is formed between the cover part 222 and the liquid channel part 11. The diameter of the cover part 222 is greater than the diameter of the tube shaft 221 and less than the diameter of the liquid channel part 11, so there is a gap between the cover part 222 and the liquid channel part 11. The sealing piston 223 is sleeved on the tube shaft 221 to seal the gap, the tube shaft 221 is set at least one through hole 221a near the bottom end of the cover part 222, one end of the second spring 224 abuts against the inner connection tube 215b of the second piston member 215, the other end of the second spring 224 abuts against the sealing piston 223, and the second spring 224 makes the sealing piston 223 abut against the cover part 222 and the outside of the tube shaft 221 to seal the through hole 221a, so that the liquid space LS is communicated one-way towards the tube shaft 221. In other words, under normal conditions, the sealing piston 223 makes the tube shaft 221 not communicated to the liquid channel part 11.

Referring to FIGS. 3 and 4, in order to avoid the reference numerals interfering with the display of flow lines, so FIG. 4 fails to show the reference numerals, the corresponding reference numerals of FIG. 4 can refer to the reference numerals of FIG. 3. As shown in FIG. 3 and FIG. 4, when the pressing head 211 of the pressing part 21 is subjected to an external force and drives the liquid guiding part 22 to move down, and the first spring 23 is compressed to accumulate elastic potential energy, the volume of the liquid space LS containing the liquid in the liquid channel part 11 (below the cover part 222 in the drawing) becomes smaller, and a one-way valve 5 in the liquid channel part 11 is closed, so the liquid pressure rises. The liquid with high pressure pushes the sealing piston 223 upwards from the gap between the cover part 222 and the liquid channel part 11, and once the liquid pressure overcomes the pressure of the second spring 224 applied to the sealing piston 223, the sealing piston 223 is lifted up by the liquid to reveal the originally sealed through hole 221a, after which the liquid can enter the tube shaft 221 from the through hole 221a, then enters the gas-liquid mixing space GLS in the gas-liquid mixing tube 215c of the second piston member 215 through the one-way valve 5 of the second piston member 215. The liquid pressure will gradually decrease after the liquid flows into the through hole 221a, until the pressure applied by the second spring 224 cannot be overcome, the sealing piston 223 will re-seal the through hole 221a, blocking the communication between the tube shaft 221 and the liquid channel part 11. In addition, when the pressing head 211 of the pressing part 21 is pressed by the external force, the volume of the gas space GS will also decrease, the air pressure increases, while the outer abutting top flange 213b of the first piston member 213 will be far away from the inner abutting top flange 31 of the upper shell body 3 and forms a gap. Since the one-way intake piston 216 does not allow the gas of the gas space GS to enter the external atmosphere in reverse, the gas of the gas space GS can only pass through the gas channel 215a of the second piston member 215, the one-way intake valve body 214 and the gap between the gas-liquid mixing tube 215c of the second piston member 215 and the first piston member 213 to enter the gas-liquid mixing space GLS in the gas-liquid mixing tube 215c of the second piston member 215 and mixes with the liquid, after which a foam is formed by the mesh gas-liquid mixing piece 213a of the first piston member 213, and then the foam is discharged through the pressing head 211.

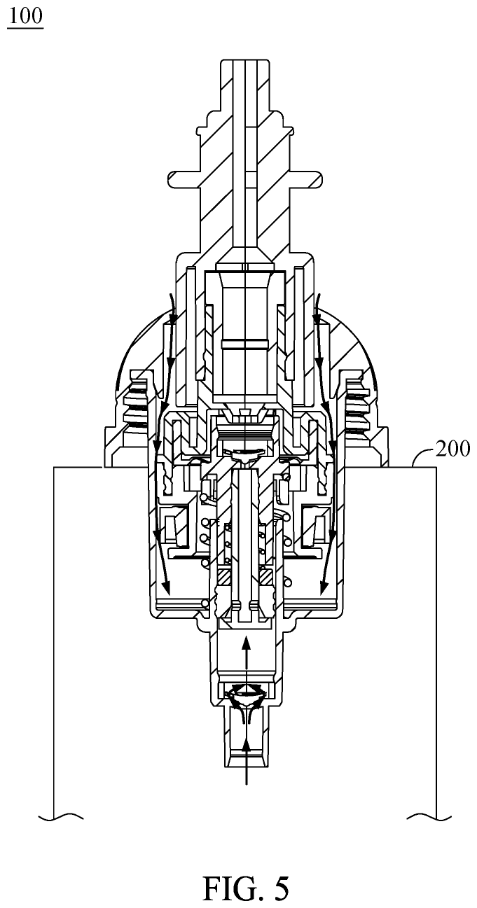

Referring to FIGS. 3 and 5, in order to avoid the reference numerals interfering with the display of flow lines, so FIG. 5 fails to show the reference numerals, the corresponding reference numerals of FIG. 5 can refer to the reference numerals of FIG. 3. As shown in FIG. 3 and FIG. 5, when the external is removed, the pressing part 21 gradually returns by the first spring 23 releasing the elastic potential energy, at this time the volume of the gas space GS increases, but the original storage of gas has been discharged, so the pressure of the gas space GS is smaller than the air pressure of the external atmosphere. Therefore, the external atmosphere will squeeze the one-way intake piston 216 through the gap between the pressing head 211 and the upper shell body 3, the gap between the outer abutting top flange 213b and the inner abutting top flange 31, the gap between the outer abutting top flange 213b and the outer shell part 12, and the gap between the second piston member 215 and the outer shell part 12, so that the gas space GS and the external atmosphere can be communicated, the external atmosphere can flow into the gas space GS to supplement the gas. When the pressing part 21 returns to the outer abutting top flange 213b of the first piston member 213 setting against the inner abutting top flange 31 of the upper shell body 3, the external atmosphere stops flowing into the gas space GS. In addition, when the external force is removed, the liquid guiding part 22 gradually returns by the first spring 23 releasing the elastic potential energy, at this time the volume of the liquid space LS increases, but the original storage of liquid has been discharged, so the pressure of the liquid space LS is smaller than the pressure of the external atmosphere. Therefore, the external atmosphere will push the liquid in the liquid container 200 into the liquid space LS in the liquid channel part 11 for supplementing the liquid through the one-way valve 5 of the liquid channel part 11. When the liquid guiding part 22 returns to the outer abutting top flange 213b of the first piston member 213 setting against the inner abutting top flange 31 of the upper shell body 3, the liquid stops flowing into the liquid space LS.

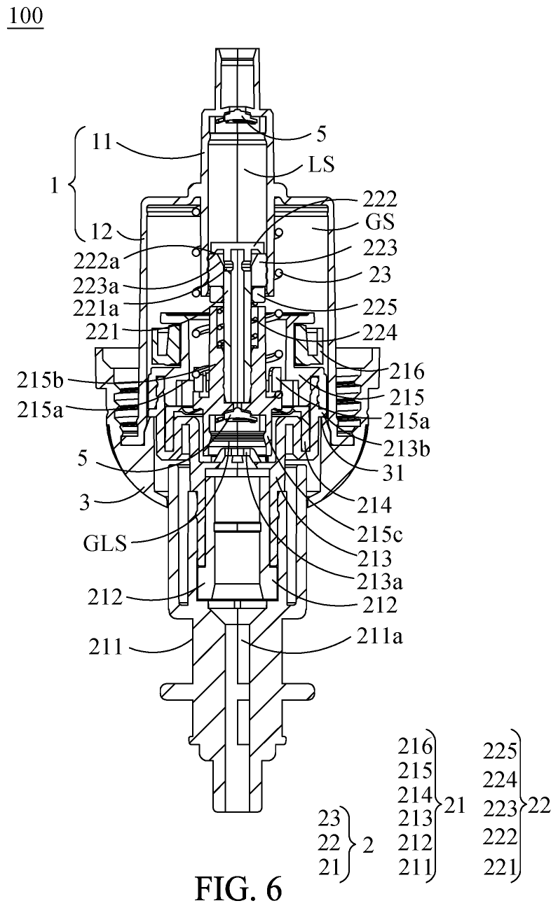

As shown in FIG. 6, when the leakproof gas-liquid mixing pump 100 of the invention is in the situation of inversion, the second spring 224 can make the cover part 222 still close to the sealing piston 223, the sealing piston 223 is still close to the tube shaft 221 to seal the through hole 221a, gravity fails to affect the normal blocking of the tube shaft 221 and the liquid space LS of the liquid channel part 11. Even if the pressing head 211 of the pressing part 21 is slightly pressed, as long as the liquid pressure cannot overcome the pressure of the second spring 224 applied to the sealing piston 223, the tube shaft 221 and the liquid space LS of the liquid channel part 11 remains uncommunicated. Therefore, the invention can make the gas-liquid mixing pump used upside down without leakage. In addition, the structure of the leakproof gas-liquid mixing pump 100 of the invention adopts two external springs, the soap liquid does not come into contact with the spring, which prevents the contamination of the soap liquid and corrosion to the spring to cause ineffectiveness of the spring.

In the embodiment, as shown in FIG. 1 and FIG. 3, an outer perimeter 222a of the cover part 222 projects towards the sealing piston 223, and the sealing piston 223 abuts against the outer perimeter 222a instead of the entire cover part 222. By reducing the contact area between the sealing piston 223 and the cover part 222, the second spring 224 can be applied with relatively small force to obtain a greater pressure.

In the embodiment, as shown in FIG. 1 and FIG. 3, the sealing piston 223 has a guiding bevel 223a, the guiding bevel 223a is located on the inside of the bottom of the sealing piston 223 and close to the cover part 222. As long as the sealing piston 223 is slightly lifted upward, the liquid may follow the guiding bevel 223a to flow into the through hole 221a without the need that the entire sealing piston 223 is far from the through hole 221a.

Further, as shown in FIG. 1 and FIG. 3, the liquid guiding part 22 of the leakproof gas-liquid mixing pump 100 of the invention further comprises an abutting top ring 225, the abutting top ring 225 surrounds the tube shaft 221 and abuts between the sealing piston 223 and the second spring 224. The second spring 224 can abut against the sealing piston 223 by the abutting top ring 225 to increase the area of the second spring 224 abutting against the sealing piston 223.

Further, as shown in FIG. 1 and FIG. 3, the leakproof gas-liquid mixing pump 100 of the invention further comprises two one-way valves 5, which are respectively located in the liquid channel part 11 and the gas-liquid mixing tube 215c of the second piston member 215 of the pressing part 21. The one-way valve 5 is used to limit the flow of liquid only one way, regardless of placing upright or upside down, it has the effect. In the embodiment, the one-way valve 5 may be a butterfly valve disc, replacing the ball valve with glass ball or steel ball, so it can be used upside down. When the pressing part is pressed, the liquid is instantly flowing into the gas-liquid mixing space GLS, which causes the butterfly valve disc made of a plastic disc slightly to be bent, so that the liquid flows in from the side of the butterfly valve disc, when the force on the pressing part is removed, the butterfly valve disc returns to the original position from the bending deformation, and blocks the liquid, so it is suitable to use upside down. In addition, when the force on the pressing part is removed, the liquid is instantly flowing into the liquid space LS, which causes the butterfly valve disc made of a plastic disc slightly to be bent, so that the liquid flows in from the side of the butterfly valve disc, when the pressing part is pressed, the butterfly valve disc returns to the original position from the bending deformation, and blocks the liquid, so it is suitable to use upside down. The one-way valve 5 has the advantages of handy and easy assembly, however, the present invention is not limited to herein, the one-way valve 5 can be replaced by other kinds of one-way valve mechanism.

As shown in FIG. 1 and FIG. 3, in the embodiment, the one-way intake piston 216 of the pressing part 21 of the leakproof gas-liquid mixing pump 100 of the invention may be a soft piston of wear-resistant soft rubber. The soft piston can ensure better sealing, less friction on the inner wall, and less pull-back force required for the pump, extending the life of the pump.

While the present disclosure has been described by means of specific embodiments, numerous modifications and variations could be made thereto by those skilled in the art without departing from the scope and spirit of the present disclosure set forth in the claims. The above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. A leakproof gas-liquid mixing pump, used for connecting a liquid container, comprises:
a lower shell body, comprising a liquid channel part and an outer shell part, the outer shell part surrounds the liquid channel part;
a pressing member, comprising a pressing part, a liquid guiding part and a first spring, the pressing part has a gas-liquid mixing channel, the liquid guiding part is communicated one-way towards the pressing part, the first spring abuts between the pressing part and the lower shell body to make the liquid guiding part set movably in the liquid channel part, a liquid space is formed between the liquid guiding part and the liquid channel part, the liquid container is communicated one-way towards the liquid space through the liquid channel part, the liquid space is communicated one-way towards the liquid guiding part, a gas space is formed between the pressing part, the liquid channel part and the outer shell part, the gas space is communicated one-way towards the pressing part, and the outer atmosphere is communicated one-way towards the gas space; and
an upper shell body, surrounding the pressing member and is connected to the outer shell part and the liquid container;
wherein the liquid guiding part comprises a cover part, a sealing piston, a second spring and a tube shaft which is communicated one-way towards the pressing part, the cover part is connected to a bottom end of the tube shaft, the diameter of the cover part is greater than the diameter of the tube shaft and less than the diameter of the liquid channel part, the tube shaft is set at least one through hole near the cover part, the second spring makes the sealing piston abut against the cover part to seal the through hole, so that the liquid space is communicated one-way towards the tube shaft.

2. The leakproof gas-liquid mixing pump according to claim 1, wherein an outer perimeter of the cover part projects towards the sealing piston, and the sealing piston abuts against the outer perimeter.

3. The leakproof gas-liquid mixing pump according to claim 1, wherein the sealing piston has a guiding bevel, the guiding bevel is located on the inside of the bottom of the sealing piston and close to the cover part.

4. The leakproof gas-liquid mixing pump according to claim 1, wherein the liquid guiding part comprises an abutting top ring, the abutting top ring surrounds the tube shaft and abuts between the sealing piston and the second spring.

5. The leakproof gas-liquid mixing pump according to claim 1, wherein the leakproof gas-liquid mixing pump used upside down further comprises two one-way valves, which are respectively located in the liquid channel part and the pressing part to make the liquid container communicated one-way towards the liquid space through the liquid channel part and make the liquid guiding part communicated one-way towards the pressing part.

6. The leakproof gas-liquid mixing pump according to claim 1, wherein the leakproof gas-liquid mixing pump used upside down further comprises a one-way intake piston, the one-way intake piston is sleeved on the pressing part so that the external atmosphere is communicated one-way towards the gas space.

7. The leakproof gas-liquid mixing pump according to claim 6, wherein the one-way intake piston is a soft piston.

8. The leakproof gas-liquid mixing pump according to claim 1, wherein the leakproof gas-liquid mixing pump used upside down further comprises a mesh gas-liquid mixing piece, and mesh gas-liquid mixing piece is set in the pressing part.

9. The leakproof gas-liquid mixing pump according to claim 1, wherein the leakproof gas-liquid mixing pump used upside down further comprises a one-way intake valve body, and the one-way intake valve body is set in the pressing part to make the gas space communicated one-way towards the pressing part.
